(19) United States
(12) Patent Application Publication
(10) Pub. No.: US 2016/0156631 A1
(43) Pub. Date: Jun. 2, 2016

(54) METHODS AND SYSTEMS FOR SHARED FILE STORAGE

(71) Applicants: Kapaleeswaran VISWANATHAN, Bangalore (IN); Arim Kumar G., Bangalore (IN); Guruprasad B. KINI, Bangalore (IN); HEWLETT-PACKARD DEVELOPMENT COMPANY, L.P., West Houston, TX (US)

(72) Inventors: Kapaleeswaran VISWANATHAN, Bangalore (IN); Arun Kumar GOPALAKRISHNANNAIR, Bangalore (IN); Guruprasad B. KINI, Bangalore (IN)

(21) Appl. No.: 14/764,229

(22) PCT Filed: Jan. 29, 2013
(86) PCT No.: PCT/IN2013/000058

§ 371 Date: Jul. 29, 2015

(51) Int. Cl. H04L 29/06; G06F 21/62; G06F 17/30

(52) U.S. Cl. CPC H04L 63/101; H04L 63/123; G06F 17/30091; G06F 21/6218; G06F 17/30958

(57) ABSTRACT

Systems and Methods for providing access control to files stored on a shared file storage platform in a multi-user environment are described herein. According to the present subject matter, the system(s) implement the described methods for receiving a request from a user device of a user from amongst a plurality of users, to perform an operation in relation to a file. Further determining a global unique identifier (GUID) associated with the file where the GUID uniquely distinguishes the file from other files based on contents of the file. The method further includes executing the requested operation in relation to the file based on an access reference graph (ARG), where the ARG provides an access control data structure to the files stored on the shared file storage platform, and where the ARG references the files stored on a shared file storage platform based on the GUID associated with each file.

### BACKGROUND

Information generated and stored in an enterprise may exist in many shapes and forms. The information may be distributed throughout the enterprise and managed by using various techniques depending on the task at hand. The increasing use of data processing and data generation in such enterprises produces ever-increasing amounts of information which have to be stored for short, medium, or long periods. In particular, the information has also to be kept ready for re-use. To maintain such information, such as data logs and files, enterprises generally implement data management and file storage systems that provide efficient and easy solutions to manage the information. For example, an enterprise may use an application for its users to tap into relational databases or a document management application to access documents pertinent to their work, hence providing shared file storage and data management facility to the users.

### BRIEF DESCRIPTION OF FIGURES

The detailed description is described with reference to the accompanying figures. In the figures, the left-most digit(s) of a reference number identifies the figure in which the reference number first appears. The same numbers are used throughout the figures to reference like features and components. Systems and/or methods, in accordance with examples of the present subject matter are now described, by way of example, and with reference to the accompanying figures, in which:

FIG. 1(a) illustrates a communication network environment implementing a system for access control of files stored on shared file storage, in accordance with an example of the present subject matter;

FIG. 1(b) illustrates a distribution of users into different groups, in accordance with an example of the present subject matter;

FIG. 2 illustrates an Access Reference Graph (ARG) as an access control data structure for the files stored on the shared file storage, in accordance with an example of the present subject matter;

FIG. 3(a) illustrates a call flow diagram depicting exchange of information between a user and entities of a file storage system for the purpose of file creation, in accordance with an example of the present subject matter;

FIG. 3(b) illustrates a call flow diagram depicting exchange of information between a user and entities of a file storage system for the purpose of file update, in accordance with an example of the present subject matter;

FIG. 3(c) illustrates a call flow diagram depicting exchange of information between a user and entities of a file storage system for the purpose of file deletion, in accordance with an example of the present subject matter;

FIG. 4 illustrates a method for providing access control to a file stored on a shared file storage platform, in accordance with an example of the present subject matter; and

FIG. 5 illustrates, as an example, another communication network environment for access control of files stored on shared file storage, in accordance with principles of the present subject matter.

### DETAILED DESCRIPTION

Systems and methods for shared file storage and access control of such shared file storage are described herein. The methods can be implemented in various computing devices connected through various networks. Although the description herein is with reference to computing devices used for multi-user shared file storage, the methods and described techniques may be implemented in other systems, albeit with a few variations.

In a present day environment, information is created every second by different users around the globe. Enterprises may have offices in different geographic locations from where different users are interconnected by way of complex and secured networks and generate information. Such enterprises may be equipped with state of the art facilities and resources, however, presently available mechanisms for information management either fail to provide an effective access control mechanism while providing efficient storage solutions, or fail to provide efficient storage solutions while providing an effective access control mechanism. For example, file storage systems, which allow substantially un-restricted control of a file to a user, may store files of other users at different locations to provide substantially un-restricted control. Although such solutions provide absolute control to users over files, these solutions are storage extensive and require a large storage space as more often than not, multiple copies of a single file are stored for different users.

File storage systems implementing efficient storage techniques to store files generally provide access control through Access Control Lists (ACLs). Essentially an ACL is a stored list of information that includes a list of authorized entities or users as well as a list of files or objects in the file storage system. The file storage system may then consult the ACL to determine whether, for example, a request by a user to access a file can be allowed or not. However, such ACL based file storage systems suffer with scalability issues when implemented in a distributed computing system. For example, the ACLs used by a file storage system increases in size exponentially with the increase in number of users and files involved and therefore, storage of data corresponding to such ACLs may become inefficient and uneconomical.

Further, as the number of users increase, the number of access requests increase, which may overload the file storage system. Moreover, as individual users are to be authenticated for access to the files, with the increase in the number of users, large number of requests need to be catered to. The increasing processing load of ACLs may result into queuing of each request and therefore, scalability is a challenge in implementation of ACLs.

According to an implementation of the present subject matter, systems and methods for file storage and access control based on an Access Reference Graph (ARG) in a shared file storage and multi-user environment are described herein. On the one hand the described methods enable efficient file storage in a multi-user environment; on the other hand, it provides scalable and reliable access control of the files to the users.

According to the described implementation of the present subject matter, the ARG is utilized to provide stand-alone capability based access control data structures where, based on the implemented ARGs, files of an enterprise can be referenced with their global unique identifiers (GUID), such as hash values. In other words, each file which is to be stored on a shared file storage platform may be referenced based on its GUID and, the reference to these files may be stored in the form of the ARG for providing the access control data structure.

The ARG graph provides a pure capability data structure. In the implementations of the present subject matter, the ARG is a graph of pseudorandom and globally unique file-numbers as nodes with the ability to securely access a file and its previous versions as an ordered set of files represented as edges that connect to the nodes. In one implementation, a global ARG can be accessed by multiple users and user groups through secure communication channels to perform various functions, such as read, write, and/or execute a file.

Since the file storage system utilizes the ARG as a data structure for access control of files and their GUID as references, each file to be stored on the shared file storage platform may be associated with a globally unique hash value. The hash value for a file may be generated based on a cryptographic hash function such as SHA-256 and others. Such GUIDs may be used as references in the ARG by the file storage system to provide efficient file storage and effective access control.

In one implementation, the unique references generated are referenced as nodes of the ARG implemented by the file storage system and based on the unique reference of a file, a unique node of the ARG is created referencing the actual file.

The users may be provided with the functionality of addition of nodes, deletion of nodes, or modification of nodes and edges defined on the ARG. As described earlier, since each node in the ARG is defined as a globally unique file-number and each edge is defined as an ordered set of files, addition, deletion, or modification of nodes and edges signifies the action of addition of a new file, deletion of an existing file and modification of an existing file, respectively. The different functions of addition, deletion, and modification of nodes may be based on access rights available with the user. The rights of a user may be defined by the groups and sub-group to which the user is categorized into. For the sake of brevity, the description and protocol of operation with respect to each operation has been defined with respect to the following figures.

The described use and implementation of ARG as an access control data structure ensures that every file with a globally unique and confidential identifier, such as a hash value is securely stored on a shared file storage platform exactly once, irrespective of the number of independent users of the file. Such capability results in optimized use of storage services. Further, every file can also be inherently version and access controlled to promote secure file-based collaboration among its users.

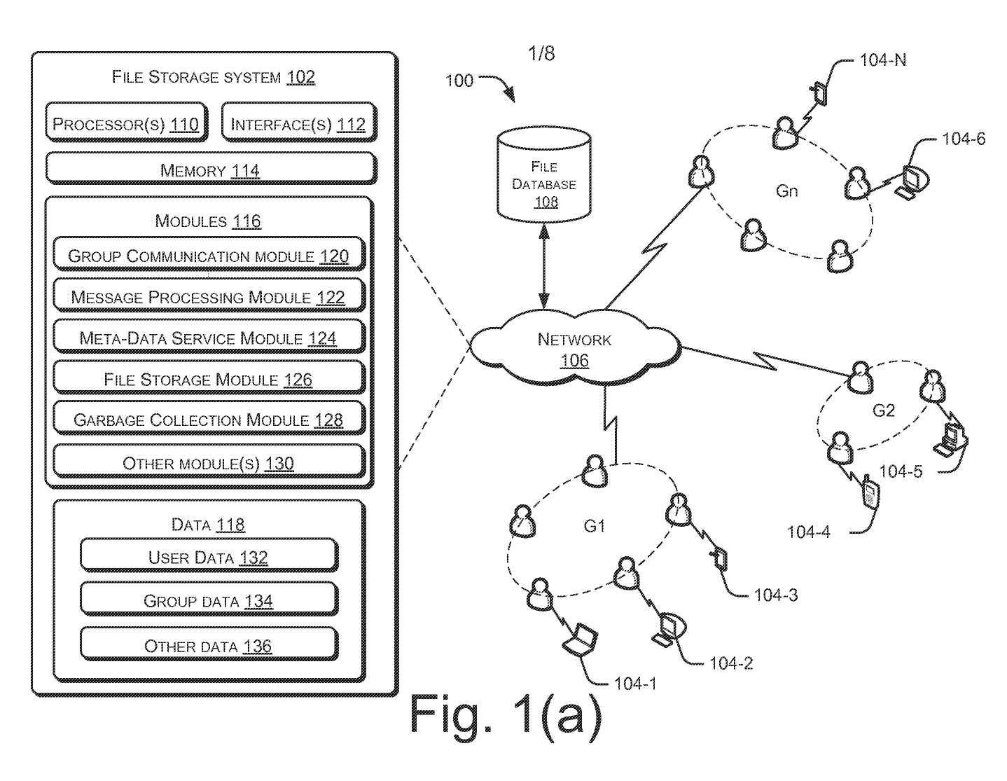

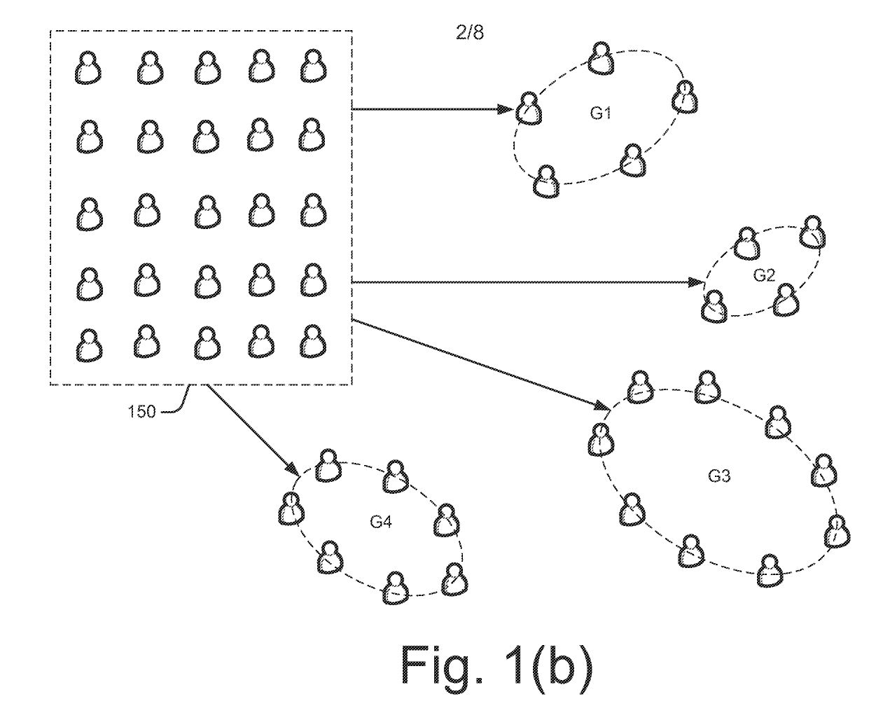

The above systems and methods are further described in conjunction with FIG. 1 to FIG. 5. It should be noted that the description and figures merely illustrate the principles of the present subject matter. It will thus be appreciated that various arrangements that embody the principles of the present subject matter, although not explicitly described or shown herein, can be devised from the description and are included within its scope. Furthermore, all examples recited herein are for pedagogical purposes to aid the reader in understanding the principles of the present subject matter. Moreover, all statements herein reciting principles, aspects, and examples of the present subject matter, as well as specific examples thereof, are intended to encompass equivalents thereof.

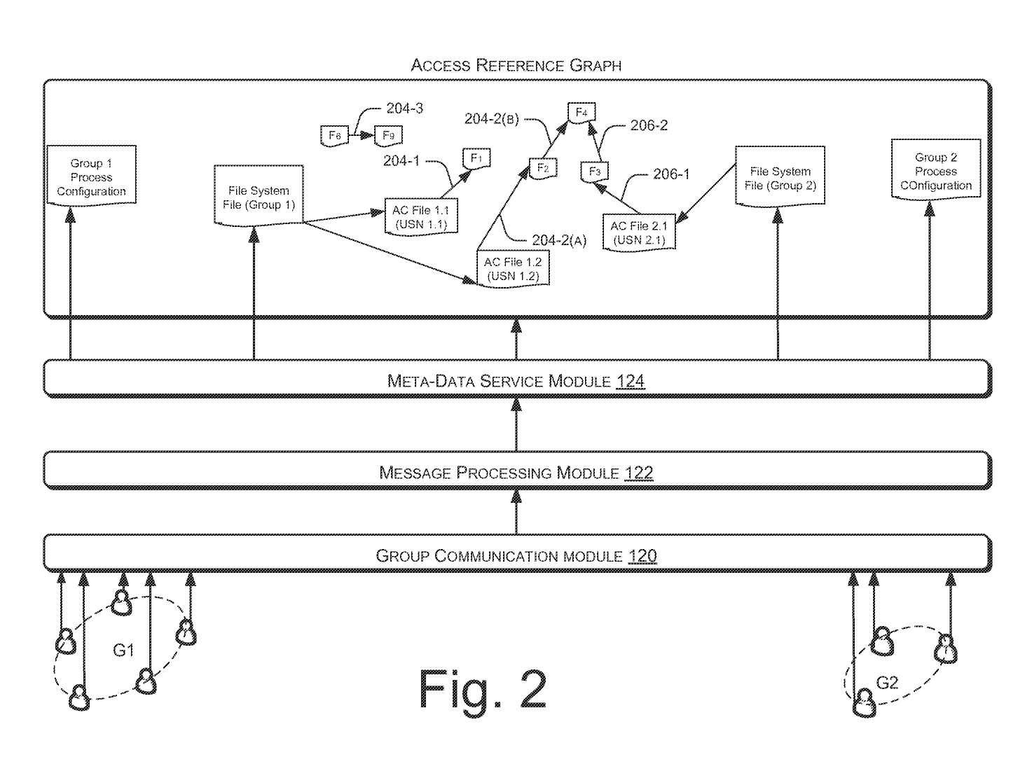

FIG. 1(a), FIG. 1(b) and FIG. 2 describe the implementation of the above described methods and techniques, in accordance with an example of the present subject matter.

FIG. 1(a) illustrates a shared file storage platform environment 100, implementing a file storage system 102 for providing effective access control and efficient file storage mechanisms, in accordance with an example of the present subject matter. FIG. 1(b) illustrates a categorization of users into different groups and sub groups, in accordance with an example of the present subject matter. FIG. 2 illustrates the inter-combination among different modules of the file storage system 102 and the implementation of an Access Reference Graph (ARG) as an access control data structure of files stored in the shared file storage platform environment 100.

The file storage system 102 has been referred to as system 102 hereinafter for the sake of simplicity and explanation. The system 102 described herein, can be implemented in any network environment comprising a variety of network devices, including routers, bridges, servers, computing devices, storage devices, etc.

In one implementation, the system 102 is connected to at least one user through user devices 104-1, 104-2, 104-3, 104-4, 104-5, 104-6, . . . , 104-N, individually and commonly referred to as user device(s) 104 hereinafter, through a network 106. In said implementation, for efficient file storage and access control, different users of the system 102 who wish to perform various operations on files stored on a shared storage may be categorized into various groups, such as G₁, G₂, . . . , Gₙ. Each such group may then be further divided into sub-groups.

In one implementation, the sub-groups may be defined as, but are not limited to, managers, updaters, readers, publishers, and messaging entities. Each user of a sub-group may be assigned with various roles based on a level of access provided to the user. For example, in the group G₁, there might be five different users where the user utilizing the user device 104-1 is categorized to the sub group manger. Further, the users utilizing the user devices 104-2 and 104-3 may be categorized to other sub group updaters. Similarly, the users of the group G2 may also be categorized into sub groups where the user utilizing the user device 104-4 is defined as a manager while the user utilizing the user device 104-5 is categorized as a reader.

In one implementation, the categorization of users into groups and sub-groups may be based on various criteria, such as seniority, trust, responsibility, and confidentiality considerations. Although any criterion or a combination of criteria described herein may be utilized, other criteria and methods of categorization of users may also be implemented. For example, as depicted in FIG. 1(b), in an organization 150 having 25 users, 4 different groups G₁, G₂, G₃, and G₄ may be formed based on geographic location of these users. Among these 4 groups, each group may include 5, 4, 9, and 7 users, respectively. The group of users may further be sub divided into sub-groups of managers, updaters, readers, publishers, and messaging entities.

As depicted in the FIG. 1(b), users categorized in the sub-group of managers may be provided with access control, such as addition and removal of users to any of the groups and sub-groups. Similarly, updaters may be provided with permission to create new nodes in the ARG corresponding to new and available files. Further, in order to prevent leakage and misuse of files, users who have a possession of a file can create nodes in the ARG. In a similar manner as described, the users of the sub-group readers may be provided an access to the files for the purpose of a read operation, whereas, the users of the sub-group publishers may be provided with an access to publish the file. Hence, the various roles of users of each group may be divided based on their rights to access the stored files.

Each such group may include multiple users and, may be located at the same or different geographic locations as depicted. Groups located at different geographic locations may either connect to the system 102 concurrently or, at different time instances, as the case may be. The user devices 104 may include multiple applications providing various mechanisms to securely connect to the system 102 through the network 106. The user devices 104 may utilize techniques know in the art, such as a Virtual Private Network (VPN) connection to provide a secure connection to the system 102.

Referring to FIG. 1(a), the system 102 can be implemented as a variety of servers and communication devices. The communication devices that may implement the system 102 may include, but not limited to, a laptop computer, a desktop computer, a notebook, a workstation, a mainframe computer, a server, and the like. The user devices 104 may be implemented as, but are not limited to, desktop computers, hand-held devices, laptops or other portable computers, tablet computers, mobile phones, PDAs, Smartphones, and the like. Further, the user devices 104 may either be stationary or mobile. They may also be understood as a mobile station, a terminal, an access terminal, a subscriber unit, a station, etc.

The network 106 may be a wireless or a wired network, or a combination thereof. The network 106 can be a collection of individual networks, interconnected with each other and functioning as a single large network (e.g., the internet or an intranet). Examples of such individual networks include, but are not limited to, Global System for Mobile Communication (GSM) network, Universal Mobile Telecommunications System (UMTS) network, Personal Communications Service (PCS) network, Public Switched Telephone Network (PSTN), and Integrated Services Digital Network (ISDN). Depending on the technology, the network 106 includes various network entities, such as gateways, routers, etc.

In one implementation, the system 102 is connected to a file database 108 through the network 106. The file database 108 may be defined as the physical location where the files stored by the users through the user device 104 are located. Although the file database 108 is illustrated external to the system 102, the file database 108 may be internal to the system 102 as well. Further, the file database 108 can be implemented as, for example, a single repository, a distributed repository or a collection of distributed repositories located at the same or different geographic locations.

In another implementation, the system 102 includes processor(s) 110. The processor(s) 110 may be implemented as microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory.

The functions of the various elements shown in the figure, including any functional blocks labeled as “processor(s)”, may be provided through the use of dedicated hardware as well as hardware capable of executing instructions.

Also, the system 102 includes interface(s) 112. The interfaces 112 may include a variety of hardware interfaces that allow the system 102 to interact with the entities of the network 106, or with each other. The interface(s) 112 may facilitate multiple communications within a wide variety of networks and protocol types, including wire networks, for example, LAN, cable, etc., and wireless networks, for example, WLAN, cellular, satellite-based networks, etc. The interface(s) 112 may facilitate a secure connection for the user devices 104 to connect to the system 102 through the network 106.

In another example of the present subject matter, the system 102 may also include a memory 114. The memory 114 may be coupled to the processor(s) 110. The memory 114 can include any computer-readable medium including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the system 102 may include module(s) 116 and data 118. The module(s) 116 and the data 118 may be coupled to the processor(s) 110. The module(s) 116, amongst other things, include routines, programs, objects, components, data structures, etc., which perform particular tasks or implement particular abstract data types. The module(s) 116 may also be implemented as, signal processor(s), state machine(s), logic circuitries, and/or any other device or component.

In another aspect of the present subject matter, the module(s) 116 may be machine-readable instructions which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

In an implementation, the module(s) 116 includes a group communication module 120, a message processing module 122, a meta-data service module 124, a file storage module 126, a garbage collection module 128, and other module(s) 130. The other module(s) 130 may include programs or coded instructions that supplement applications or functions performed by the system 102. In said implementation, the data 118 includes user data 132, group data 134, and other data 136. The other data 136 amongst other things, may serve as a repository for storing data that is processed, received, or generated as a result of the execution of modules in the module(s) 116. Although the data 118 is shown internal to the system 102, the data 118 can reside in an external repository (not shown in the figure), which may be coupled to the system 102. The system 102 may communicate with the external repository through the interface(s) 112 to obtain information from the data 118.

As mentioned before, the system 102 may provide shared file storage functionality and access control to users based on Access Reference Graph (ARG) in a shared storage and multi-user environment. In one implementation, the users connect to the system 102 through their user devices 104. The group communication module 120 of the system 102 determines the access rights of the user. The access rights of the user may be identified based on the role the user has been provided rather than the type of access the user has on any particular file. For example, as described earlier, users of different groups may be categorized into sub-groups to be provided with different roles, such as managers, updaters, readers, publishers, and messaging entities. As described earlier, users categorized in the sub-group of managers may be provided with access control such as addition and removal of users to any of the groups and sub-groups. Similarly, updaters may be provided with permission to create new nodes in the ARG corresponding to new and available files. Further, in order to prevent leakage and misuse of files, users who have a possession of a file can create nodes in the ARG. In a similar manner as described, the users of the sub-group readers may be provided an access to the files for the purpose of read operations whereas, the users of the sub-group publishers may be provided with an access to publish the file publically. Hence, the various roles of users of each group may be divided based on their allowed access to the stored files. The group communication module 120 may provide access to authorized users to perform different operations.

A user connected to the system 102 may wish to store a file or create, delete, write or update, read, and publish operations on a file. To perform any such operation, the user device 104 of the user may send a request to the system 102 through the network 106. For example, a user may wish to store a file onto the system 102 and for this purpose, the user device 104 of the user may initiate a file creation request. Upon receiving any such request from the user, in one implementation of the present subject matter, the group communication module 120 of the system 102 may authenticate the user based on different parameters, such as login details and the access rights available with the user. Upon identifying the user to be an authorized user, the request of the user may be provided to the message processing module 122 for initiation of the intended operation. The message processing module 122 may facilitate communication of messages between the meta-data service module 124 and, the users requesting an operation.

As described earlier, the system 102 utilizes ARG as capability based access control data structures. Hence, in one implementation, the system includes the meta-data service module 124 may query and control the ARG and, provide access to the users to the stored files for performing various operations. In said implementation, upon receiving a request from the users, the meta-data service 124 may query the ARG and complete the request based on the access control identified through the ARG.

The ARG may include globally unique identifier (GUID) associated with files as nodes and the edges between the nodes as relation between the GUIDs of files. FIG. 2 depicts an example of ARG utilized by the system 102 for the purpose of access control. The ARG includes nodes or vertices represented as GUID associated with each file. In one implementation, the GUID associated with each file may be computed based on a cryptographic hash function. In said implementation, the GUID may be computed based on the following equation:

f=Hash(file) Equation (1)

Where ‘f’ represents the GUID and ‘file’ represents the file for which the GUID number is generated. ‘Hash’ may represent a cryptographic hash function to generate a hash value for the file as the GUID.

In one implementation, SHA-256 may be utilized as the cryptographic hash function to generate the GUID corresponding to files. In another implementation, other cryptographic hash functions, such as MD5, RIPEMD, and others may be used for the purpose of generation of GUIDs. Further, the GUIDs are not limited to hash values generated based on cryptographic hash functions and methods other than cryptographic hash functions may be utilized for generating a GUID for a file based on its content. The hash value for a file is generated based on its content and, an identical hash value would be generated for two files with same content. Further, for files with different content, the hash value generated would be unique. In said implementation, the GUID for a file generated based on a hash function may be represented in 256 bits. Based on a 256 bit representation of the GUID, the ARG may track 2¹²⁸ different and unique files.

The ARG depicted in FIG. 2 includes the GUIDs associated with files. In one implementation, the ARG may support different types of files, such as system files and user files. User files may define the files stored and accessible to the users whereas, the system files may represent the files meant for configurations and access control purpose and might not be accessible to different users.

The files represented as ‘F₁’, ‘F₂’, ‘F₃’, ‘F₄’, ‘F₆’, and ‘F₉’ depict the nodes corresponding to user files where the GUIDs associated with each file are stored at the nodes and the files represented as file system files, such as the ‘File System File (Group 1)’ and ‘File System File (Group 2)’ represent Group's File System File that may contain a unique group number. In one implementation, the Group's file system file is connected to the root of graph, i.e., the ARG for promoting efficient graph traversal. The ARG also contains access control files which contain confidentiality and privacy preferences of the group for respective files. The files depicted as ‘AC File 1.1 (USN 1.1)’, ‘AC File 1.2 (USN 1.2)’, and ‘AC File 2.1 (USN 2.1)’ represent the access control files for each group connected to the system 102. For example, the access control file ‘AC File 1.1 (USN 1.1)’ is the access control file corresponding to Group 1. Similarly, the access control file ‘AC File 1.2 (USN 1.2)’ is also an access control file corresponding to Group 1, however, it defines access control for another file. Now, the file ‘AC File 2.1 (USN 2.1)’ is the access control file for Group 2 and provides access control for a file with respect to Group 2.

The files depicted in the ARG are for the purpose of explanation and, the ARG may include more or less number of files than depicted.

Apart from node and vertices as GUIDs corresponding to user and system files, the ARG also includes edges that define a relation between two nodes. In one implementation, an edge may either be a version edge or, may be an access reference edge. Access reference edges define the relation between two system files and between a system file and a user file. For example, the edge 204-1 is an access reference edge between the access control file ‘AC File 1.1 (USN 1.1)’ and the user file ‘F₁’. Further, the edges represented by 204-2(B) and 206-2 are the version edges and represent the versions of the files. In the described figure, the version edges 204-2(B) and 206-2 describe that the file ‘F₄’ is the latest version of both the files ‘F₂’ and ‘F₃’ as the version edge 204-2(B) describe the file F4 to be the latest version of F2 while the edge 206-2 describe the file ‘F₄’ to be the latest version of ‘F₃’. Therefore, the edges of the ARG define the relation between two nodes of the graph.

In one implementation of the present subject matter, the meta-data service module 124 upon receiving a request from the message processing module 122, may traverse through the various nodes and edges of the ARG to identify the unique reference corresponding to the file for which the request has been made by a user. For example, in case a user of group 2 (G2) wishes to read the file ‘F₄’, the request for the operation may be received by the message processing module 122 and the meta-data service module 124 may first determine the file system file of group 2, i.e., ‘File System File (Group 2)’ to traverse the access control file for the file ‘F₄’. Upon determination of the access control defined in the ‘AC File 2.1 (USN 2.1)’, the meta-data service module 124 may traverse through the edges 206-1 and 206-2 to identify the unique reference corresponding to the file ‘F₄’.

In another implementation of the present subject matter, the file storage module 126 of the system 102 may store and retrieve files from the file database 108 based on the GUID associated with the files. Hence, in the above described situation, the meta-data service module 124 may provide the identified GUID to the file storage module 126 based on which the file storage module 126 may fetch the actual file from the file database 108 and provided it to the user for a read operation.

The files ‘F₁’, ‘F₂’ and ‘F₄’ are referentially accessible to Group 1 while the files ‘F₃’ and ‘F₄’ are referentially accessible to Group 2. Further, the File ‘F₄’ is referentially accessible for both the groups 1 and 2. Further, the files ‘F₂’ and ‘F₄’ are versioned files accessible to Group 1 while the files ‘F₃’ and ‘F₄’ are versioned files which are accessible to Group 2.

In the above described situation of requesting a file for a read operation, had the user of Group 2 requested for a read operation on file ‘F₁’ instead of the file ‘F₄’, the meta-data service module 124 upon identifying the file system file ‘File System File (Group 2)’ associated with Group 2 might have not been able to traverse to any access control file that references to the file ‘F₁’ and hence would not have granted access to the file ‘F₁’ to the user of Group 2. Therefore, users belonging to groups having no access to a file may be restrained from accessing such file by the use of the ARG.

The FIG. 2 also depicts versioned files ‘F₆’, and ‘F₉’ that have no reference and are not referentially accessible to any group. Such files may be referred to as orphaned files that have been deleted by the users and cannot be accessed by traversal of the ARG. In one implementation, if for a file there has been no user left for referential access, the meta-data service module 124 deletes the edge leading to that file. For example, in case the file ‘F₄’ is deleted by the user of the Group 1 such that the file does not exist for Group 1, the meta-data service module 124, in such a situation, may delete the edge 204-2(B). The deletion of the edge 204-2(B) may make the file ‘F₄’ inaccessible for Group 1 whereas, since the edge 206-2 still exists, the file is referentially available to Group 2. Therefore, the use of ARG may allow efficient and disjunctive control over a single file by different users and different groups.

In one implementation of the present subject matter, the garbage collection module 128 may remove the GUIDs of orphaned files. Hence, if after deletion of a file by any group, the file becomes orphaned, such as the files ‘F₆’, and ‘F₉’, the garbage collection module 128 identifies such files and removes all GUIDs corresponding to the file. Upon deletion of the orphaned files, the garbage collection module 128 may also intimate the GUID of the file to permanently delete the files from the file database 108 and relinquish the space for other files to be stored. In one implementation, the garbage collection module 128 may perform the activity of identifying the orphaned files for deletion after every pre-defined time interval, such as 12 hours, 24 hours, and 48 hours. In another implementation, the meta-data service module 124 may intimate the garbage collection module 128 about the orphaned files upon deletion of edges such that the file references and the actual file can be immediately deleted.

Along with version control and access restriction, the access control file and the edges of the ARG may also define a published status of the files in certain situations. In one implementation, the edges of the ARG graph are marked to determine whether the file referenced to by the edge has been published or not. In said implementation, when a user of a group publishes a file for use by other users, the meta-data service module 124 may define the edge leading to the unique identifiers of the file as published. For example, in case a user of the Group 2 has published the file ‘F₄’ for other users, the meta-data service module 124 may mark the edge between the file ‘F₃’ and ‘F₄’ as published. This allows instant access of the file to other groups while the meta-data service module 124 may traverse the ARG to determine that the file is published for other groups as well.

In one implementation of the present subject matter, other functionalities, such as user identity service and distributed concurrency control may also be provided by the system 102 to enable efficient storage of files and ensure effective access control. The group-communication module 120 to provide user identity services may provide functionalities, such as user registration, user login services, and user message authentication. Further, to provide the distributed concurrency control, the group communication module 120 may provide concurrency control functions and co-ordination services based on which multiple users and multiple services may function concurrently.

The system 102 may implement multiple other functionalities other than described herein to provide better and efficient services to the users. Further, users may be provided the above described functionality based on a collated set of services utilizing ARG as a data structure for access control without an implementation of distributed and disintegrated set of services. Furthermore, certain services may not be implemented by the system 102 to provide limited set of functionalities and capabilities to the user. However, the use of ARG as a data structure to provide access control may provide both efficient storage of files and effective access control.

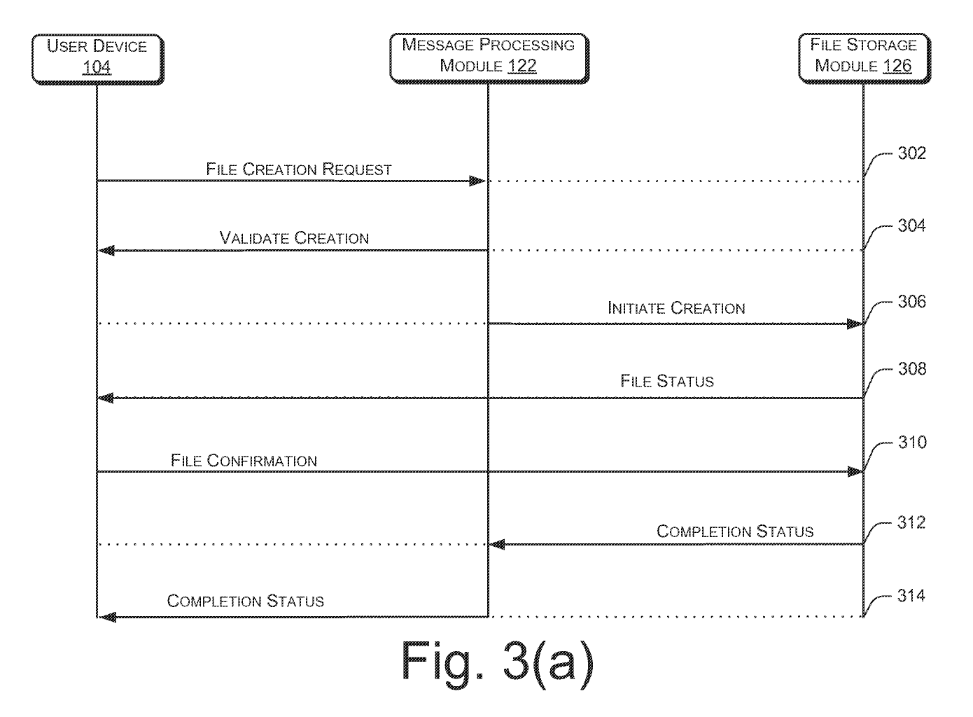

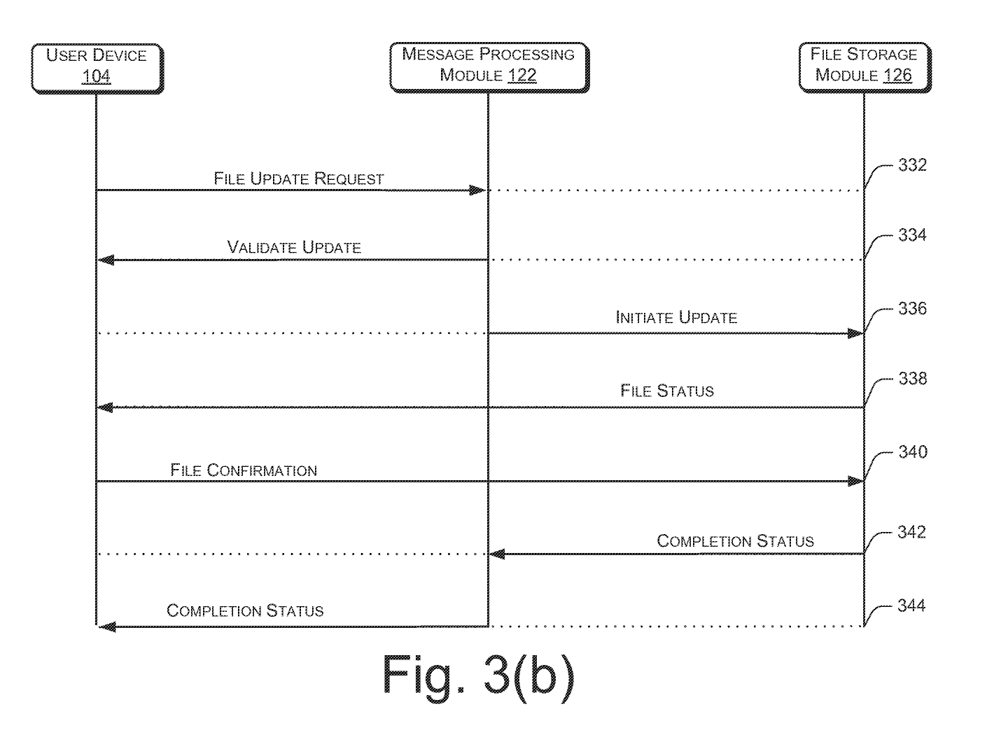

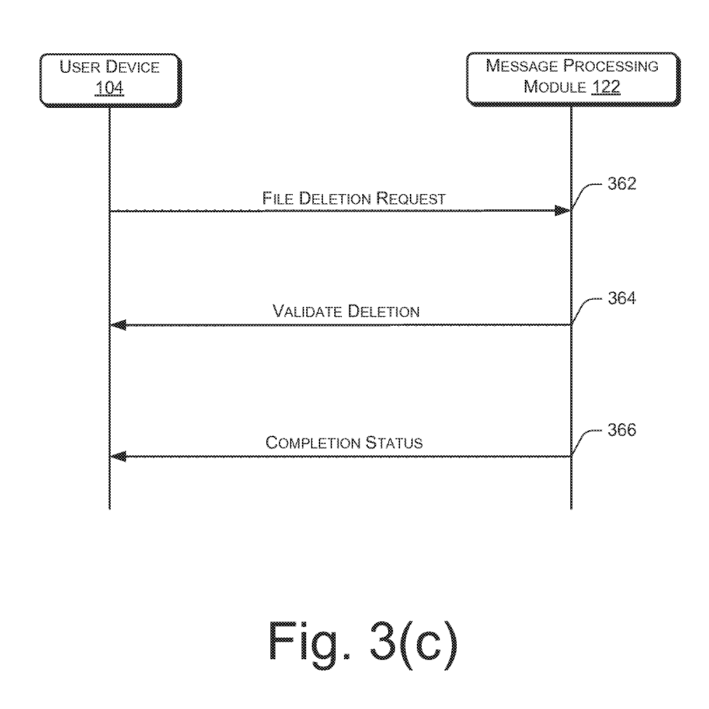

As described before, the users of various groups may wish to perform different operations on files depending upon the access available to them. The protocol for such operations may vary depending on the operations and therefore, various call flows along with associated functionality of various modules of the system 102 for such operations have been defined with respect to the accompanied FIG. 3.

FIG. 3(a), FIG. 3(b), and FIG. 3(c) illustrate call-flow diagrams indicating different operations by users on a file stored on a shared file storage platform implementing ARG as an access control data structure, in accordance with an example of the present subject matter. The various arrow indicators used in the call-flow diagram depict the transfer of information between the user devices 104, message processing module 122, and the file storage module 126. In many cases, multiple network entities besides those shown may lay between the entities, including transmitting stations, switching stations, proxy servers, authentication entities, and communication links, although those have been omitted for clarity. Similarly, various acknowledgement and confirmation network responses may also be omitted for the sake of clarity.

Further, the different functions and processes executed within an entity for the exchange of information depicted by way of the arrows have also been omitted in the diagram. However, such functions and their execution have been explained in the forthcoming description of the diagrams for the sake of understanding and clarity. The different instances of exchange of information between the message processing module 122 and the file storage module 126 have been described with reference to the call flow represented in FIGS. 3(a), 3(b), and 3(c). However, the message processing module 122 and the file storage module 126, or equivalents thereof, may be implemented in a different manner, without digressing from the scope and spirit of the present subject matter.

Referring to FIG. 3(a), the call flow diagram depicts the exchange of information between the user devices 104, the message processing module 122, and the file storage module 126 for the purpose of file creation. To create or store a file on the shared storage environment where the system 102 provides access control and access to the storage of files in the file database 108, at step 302, the user device 104 may send a file creation request to the system 102. The request may be received by the message processing module 122 for execution. In one implementation of the present subject matter, the user device 104 may send file parameters, such as path name, file name, size of file and, GUID of the file along with the file creation request at the step 302. The path name may determine the location where the file should be stored in the file database 108. The file name may signify the reference name with which the file should be stored in the file database 108. Further, the GUID of the file may uniquely identify the file and may differentiate the file from others. In said implementation, the GUID may be a hash value associated with the file that may have been derived based on a cryptographic hash function.

The message processing module 122 upon receiving such request may retrieve a corresponding Group File System File reference for that group in order to traverse the ARG efficiently. In one implementation, the message processing module 122 may cache references to Group File System File to provide better performance to the users. Based on the Group File System File and the file parameters, the message processing module 122 may verify whether the request is valid or not. In situations where the file parameters are not valid, the message processing module 122 may send a fail code through a request to the user device 104. Further, in situations where the file parameters and the group details are successfully verified by the message processing module 122, a success code may be sent through a request to the user device 104. In said implementation, the message processing module 122 may send a validate creation request to the user device 104 at the step 304. The validate creation request may include either a success code or a fail code along with other parameters, such as the GUID and the size of the file to uniquely distinguish the response of the message processing module 122.

In situations where the file parameters are successfully validated by the message processing module 122, an initiate creation request may be sent to the file storage module 126 at step 306. Through the initiate creation request, the message processing module 122 may indicate to the file storage module 126 that a user request for storage of a file has been received. In said implementation, the message processing module 122 may provide the GUID of the file along with the file size to the file storage module 126. Based on the initiate creation request and the received parameters, the file storage module 126 may determine whether the file already exists on record or not within the file database 108. In such a situation, either the file may exist or the file may not exist on record with the file database 108. Upon determination of such a condition, the file storage module 126 may provide the file status to the user device 104 through a file status request at step 308.

In case no file with the same GUID already exists within the file database 108, the user device (104) may provide the file to the file storage module 126 through the file confirmation step at 310. Further, in situations where the file status of step 308 indicates that the file already exists within the file database 108, the user device 104 may prove ownership of the file to the file storage module 126 at the step 310. In one implementation, the user device 104 may prove ownership of the file to the file storage module 126 based on a mechanism that allows users to prove to the file storage module that he is in possession of the file, without having to send the entire file to the server. For the purpose of explanation and clarity, such a mechanism has been referred to as a proof-of-ownership mechanism hereinafter.

In said implementation, upon file confirmation from the user device 104 to the file storage module 126, the file storage module 126 may indicate the completion of the file creation to the message processing module 122. In one implementation, the user device 104 may either not be able to prove ownership, or may not provide the actual file for storage to the file storage module 126. In such situations of failure, the file storage module 126 may send a fail code to the message processing module 122. Whereas, in situations where the file confirmation is successful at the step 310, the file storage module 126 may send a success code to the message processing module 122. In one implementation, depending upon the case, as it may be, the file storage module 126 may send a completion status to the message processing module 122 along with either the success code or a failure code, at step 312. In one implementation, the message processing module 122, upon receiving the completion status with a success code from the file storage module 126, may create a node corresponding to the new file stored in the ARG. The creation of the new node may also ensure that the user's Group is authorized to perform operations on the new nodes. In case the success code indicates that ownership for an already existing file has been proved, the message processing module 122 may create an access control file for the user's group corresponding to the file's GUID in the ARG. Upon a successful update of the ARG, the message processing module 122 may send a completion status message to the user device 104.

Referring to FIG. 3(b), the call flow diagram depicts the exchange of information between the user devices 104, the message processing module 122, and the file storage module 126 for the purpose of file update. To update an existing file stored on the shared file database 108, at step 332, the user device 104 may send a file update request to the system 102. The request may be received by the message processing module 122 for execution. In one implementation of the present subject matter, the user device 104 may send the file parameters, such as path name, file name, size of file and, GUID of the file along with the file update request at the step 332. The path name may signify the location where the file is stored in the file database 108. The file name may signify the reference name under which the file is stored in the file database 108 and, the GUID of the file may uniquely identify the file and may differentiate the file from others. As described earlier, the GUID may be the hash value associated with the file.

The message processing module 122 upon receiving such request may verify the update request based on the file parameters. The message processing module 122 may determine whether the request for the update of the file is with respect to an existing file. This may be done by traversing the ARG to determine the node corresponding to the GUID received in the file update request. Once the verification is complete, based on the verification, the message processing module 122 may send a validate update request to the user device 104 at step 334. As described in the file creation procedure, the validate update request may include either a fail code or a success code depending upon the result of the verification by the message processing module 122. In case the verification of the update request is successful, the message processing module 122 may send an initiate update request to the file storage module 126 at step 336. Upon receiving the request at the step 336, the file storage module 126 may determine whether the updated file exists on record with the file database 108. The determination is sent to the user device through the file status request at step 338. In case the file exists, the user device 104 may prove ownership of the updated file, or else may provide the updated file to the file storage module 126 at the step 340 through the file confirmation request.

Upon completion of the update process, the file storage module 126 may indicate a completion status of the update to the message processing module 122. Similar to the process of file creation, in case the process of file confirmation fails with the user device (104) at the step 340, the completion status at the step 342 may signify a fail code. In case the file confirmation is successful where the user device 104 either proves ownership or provides the updated file, the completion status at step 342 may include a success code. The message processing module 122 upon receiving a success code in the completion status at step 342 may either create a new node along with a version edge or may grant access to the user's group to the existing file in the ARG. In one implementation, upon completion of the update request in the ARG, the message processing module 122 may provide the confirmation status to the user device 104 at the step 344.

Referring to FIG. 3(c), the call flow diagram depicts the exchange of information between the user devices 104 and the message processing module 122 for the purpose of file deletion. To delete an existing file stored on the shared file database 108, at step 362, the user device 104 may send a file deletion request to the system 102. The request may be received by the message processing module 122 for execution. In one implementation of the present subject matter, the user device 104 may send the file parameters, such as path name, file name, size of file and GUID of the file along with the file deletion request at the step 362. The path name may signify the location where the file is stored in the file database 108. The file name may signify the reference name under which the file is stored in the file database 108 and the GUID of the file may uniquely identify the file and may differentiate the file from others. As described earlier, the GUID may be the hash value associated with the file.

Upon receiving the file deletion request at the step 362, the message processing module 122 may verify the file deletion request based on the file parameters. The message processing module 122 may send a validate deletion request to the user device 104. The validate deletion request may include a fail code in case the deletion request has been declined based on verification of the file parameters. Similarly, the validate deletion request may include a success code when the file deletion request has been successfully validated by the message processing module 122.

In one implementation of the present subject matter, upon successfully verifying the file deletion request, the message processing module 122 may delete the edge referencing to the GUID of the file in the ARG. In such situations, the message processing module 122 may not communicate with the file storage module 126 for actual deletion of the file from the file database 108. As described before, once upon deletion of all the edges referencing to a file in the ARG, the garbage collection module 128 may delete the file from the file database 108. Therefore, to delete access to the file, the message processing module 122 may delete the edge in the ARG referencing to the file. Upon successful deletion of the edge, the message processing module 122 may indicate a completion status of the file deletion request to the user device 104.

As described above, various operations may be handled by the message processing module 122 and the file storage module 126 of the system 102 in the described manner. Similar to the above described call flow, similar call flows may exist with slight variations among the entities, such as the user device 104 and the message processing module 122 to provide other operations other than described. The details of such flows have been omitted for the sake of brevity.

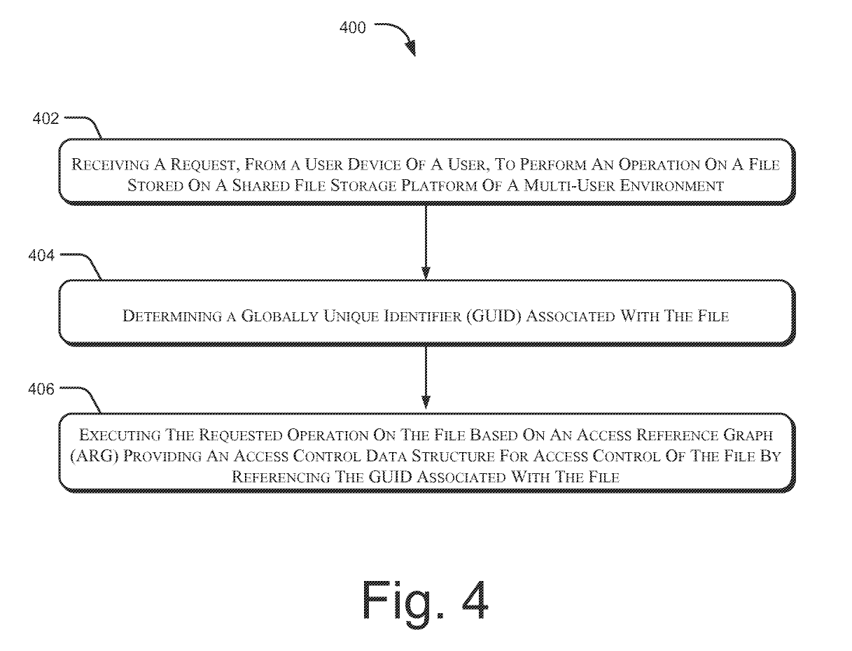

FIG. 4 illustrates method 400 for providing efficient file storage and access control based on an Access Reference Graph (ARG) data structure, according to an example of the present subject matter. The order in which the method 400 is described is not intended to be construed as a limitation, and any number of the described method blocks can be combined in any order to implement the method 400, or any alternative methods. Additionally, individual blocks may be deleted from the method without departing from the spirit and scope of the subject matter described herein.

It would be recognized that steps of the method can be performed by programmed computers. Herein, some examples are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The examples are also intended to cover both communication network and communication devices configured to perform said steps of the methods.

Referring to FIG. 4, at block 402, a request, from a user device of a user is received to perform an operation on a file stored on a shared file storage platform of a multi-user environment. The operation may be a read, store/create, delete, update, or publish operation. In one implementation, a file storage system, such as the system 102 may be utilized to execute the operations in an efficient and effective manner.

At block 404, a globally unique identifier (GUID) associated with the file is determined. In one implementation, the GUID may be a hash value generated for the file based on a cryptographic hash function. The GUID associated with the file may uniquely identify the file and distinguish it from the other files stored on the shared file storage platform.

At block 406, the requested operation on the file is executed based on an access reference graph (ARG) providing an access control data structure for access control of the file by referencing the GUID of the file. In other words, based on the GUID identified for the file, the ARG may provide access control to the file, where the ARG is the access control data structure including GUID of the file as a reference to the file. In one implementation, the ARG is a graph of pseudorandom and globally unique file-identifiers as nodes with the ability to securely access an ordered set of files as edges that connect the nodes. In said implementation, the ARG is accessed to execute the operation requested by a user of a multiple user environment.

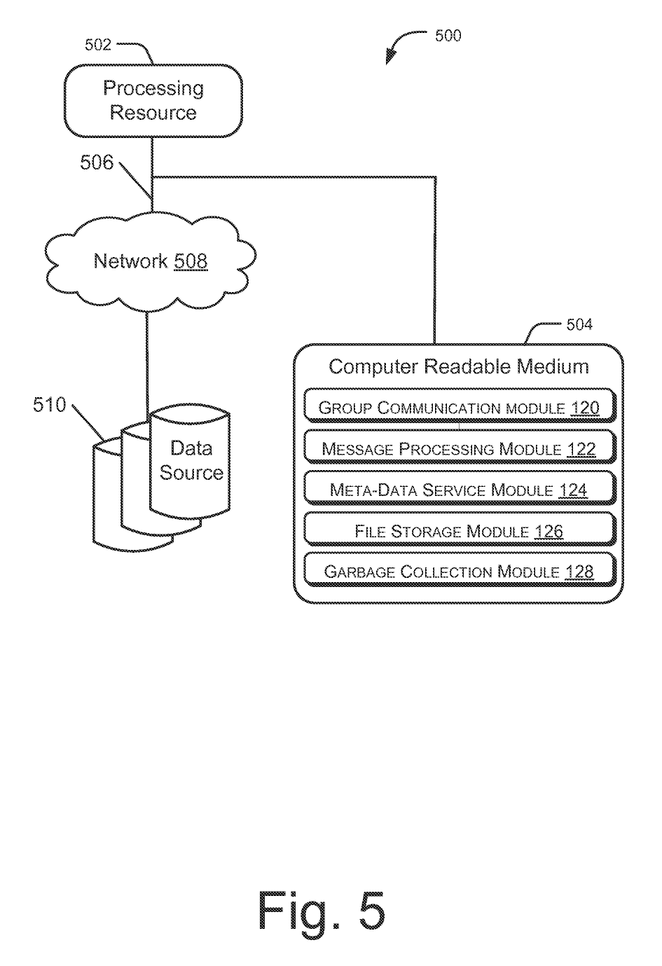

FIG. 5 illustrates, as an example, another communication network environment for access control of files stored on shared file storage, in accordance with principles of the present subject matter. The communication network environment 500 may be a public communication network environment or a private communication network environment. In one implementation, the communication network environment 500 includes a processing resource 502 communicatively coupled to a computer readable medium 504 through a communication link 506.

For example, the processing resource 502 can be a computing device, such as a server, a laptop, a desktop, a mobile device, and the like. The computer readable medium 504 can be, for example, an internal memory device or an external memory device. In one implementation, the communication link 506 may be a direct communication link, such as any memory read/write interface. In another implementation, the communication link 506 may be an indirect communication link, such as a network interface. In such a case, the processing resource 502 can access the computer readable medium 504 through a network 508. The network 508 may be a single network or a combination of multiple networks and may use a variety of different communication protocols.

The processing resource 502 and the computer readable medium 504 may also be communicatively coupled to data sources 510 over the network 508. The data sources 510 can include, for example, databases and computing devices. The data sources 510 may be used by the users to store files, similar to the file database 108.

In one implementation, the computer readable medium 504 includes a set of computer readable instructions, such as the group communication module 120, the message processing module 122, meta-data service module 124, file storage module 126, and garbage collection module 128. The set of computer readable instructions can be accessed by the processing resource 502 through the communication link 506 and subsequently executed to perform acts for providing access control for files stored in the shared file storage platform. In one implementation, the computer readable medium 504 may provide shared file storage functionality and access control to users based on an Access Reference Graph (ARG) in a shared storage and multi-user environment.

For example, the group communication module 120 may determine the access rights of the user. The access rights of the user may be identified based on the role the user has been provided rather than the type of access the user has on any particular file. The meta-data service module 124 may query and control the ARG and, provide access to the users to the stored files for performing various operations. In said implementation, upon receiving a request from the users, the meta-data service module 124 may query the ARG and complete the request based on the access control identified through the ARG. Based on the ARG, users may perform different operations, such as read, write, and/or execute a file.

The meta data service module 124 may also identify a copy of the file associated with the GUID to exist on the data source 510 of the shared file storage platform, to create a file. Further, the garbage collection module 128 may determine orphaned nodes in the ARG so as to delete files corresponding to the determined orphaned nodes from the data source 510 where the orphaned nodes of the ARG are nodes not referenced by an edge of the ARG.

In one implementation of the present subject matter, based on the described methods and techniques, file-based social networking functionality can also be realized. Different users with similar interest in any particular or common file can be identified based either on their possession or access of similar rights on the file. In other words, users who may either be trying to save a similar file onto the shared file storage platform, or having similar access rights to a file stored onto a shared file storage environment may be identified to have similar or common interests. Since a file with similar contents has a globally unique identifier, users with specific interest in any one common GUID may be identified to have similar interests and the users can explore for shared interest amongst themselves due to their individual interest in the common file.

Furthermore, security threats to a file can be monitored in real time as a file marked to be confidential by one set of users can be observed and any operation by an unauthorized group of users, such as storage or publication can be identified. Further, since the GUID for each file is based on its content, reference to any two similar files would remain unique and reflect onto a single node on the ARG, thereby allowing efficient monitoring of security threats.

Although examples for methods and systems for providing access control for shared file storage based on access reference graph (ARG) have been described in a language specific to structural features and/or methods, the present subject matter is not necessarily limited to the specific features or methods described. Rather, the specific features and methods are disclosed as examples for providing access control based on ARG.

What is claimed is:

1. A method to provide access control to files stored on a shared file storage platform in a multi-user environment, the method comprising:
receiving a request from a user device (104) of a user from amongst a plurality of users, to perform an operation in relation to a file;
determining a global unique identifier (GUID) associated with the file, the GUID uniquely distinguishes the file from other files based on contents of the file; and
executing the requested operation in relation to the file based on an access reference graph (ARG), wherein the ARG provides an access control data structure to the files stored on the shared file storage platform, and the ARG references the files stored on a shared file storage platform based on the GUID associated with each file.

2. The method as claimed in claim 1, wherein the executing comprises identifying a copy of the file associated with the GUID to exist on a file database (108) of the shared file storage platform, wherein the operation is of creating the file.

3. The method as claimed in claim 2 further comprising requesting the user to prove possession of the file based on the identifying, wherein the copy of the file already exists on the file database (108).

4. The method as claimed in claim 2 further comprising requesting the user to provide the file for storage in the file database (108) based on the identifying, wherein the copy of the file does not exist on the file database (108).

5. The method as claimed in claim 4, wherein the method further comprises creating a node in the ARG for the GUID of the file, wherein the node is referenced through an edge of the ARG providing access to the node.

6. The method as claimed in claim 1, wherein the operation is one of reading the file, creating the file, updating the file, publishing the file, and deleting the file.

7. The method as claimed in claim 1, wherein the GUID associated with the file is a hash value generated for the file based on a cryptographic hash function.

8. The method as claimed in claim 1, wherein the executing comprises deleting an edge of the ARG referencing to the GUID of the file stored on a file database (108) of the shared file storage platform, wherein the operation is deleting the file.

9. The method as claimed in claim 1 further comprising determining orphaned nodes in the ARG to delete files corresponding to the determined orphaned nodes from a file database (108) of the shared file storage platform, wherein the orphaned nodes of the ARG are the nodes not referenced by an edge of the ARG.

10. The method as claimed in claim 1, wherein the method further comprises receiving file parameters along with the request to perform the operation, wherein the file parameters comprise at least one of a GUID associated with the file, a size of the file, a path name associated with the file, and a file name.

11. A file storage system (102) for providing access control to files stored on a shared file storage platform in a multi-user environment comprising:
at least one processor (110);
a group communication module (120) coupled to the processor (110) to receive a request from a user device (104) of a user from amongst a plurality of users and perform an operation in relation to a file;
a meta-data service module (124) coupled to the processor (110) to:
determine a global unique identifier (GUID) for the file, wherein the GUID uniquely distinguishes the file from other files based on contents of the file; and
execute the requested operation in relation to the file based on an access reference graph (ARG), wherein the ARG provides an access control data structure for the files stored on the shared file storage platform, and the ARG references the files stored on a shared file storage platform based on global unique identifiers (GUIDs) associated with each file; and
a file storage module (126) coupled to the processor (110) to identify a copy of the file associated with the GUID to exist on a file database (108) of the shared file storage platform, wherein the operation is of creating the file.

12. The file storage system (102) as claimed in claim 11 further comprising a garbage collection module (128) to determine orphaned nodes in the ARG so as to delete files corresponding to the determined orphaned nodes from a file database (108) of the shared file storage platform, wherein the orphaned nodes of the ARG are nodes not referenced by an edge of the ARG.

13. The file storage system (102) as claimed in claim 11, wherein the meta-data service module (124) is further to traverse the ARG to identify a node as a system file reference, wherein the system file reference comprises one of a group's file system file reference and an access control file reference, and wherein the group's file system file includes a unique group number and the access control file includes confidentiality and privacy preference of a group of users.

14. The file storage system (102) as claimed in claim 11, wherein the meta-data service module (124) is further to traverse the ARG to identify an edge as one of a version edge and a system access reference edge, and wherein the version edge connects a newer version of the file with an older version of the file.

15. A non-transitory computer readable medium comprising instructions executable by a processor to:
receive a request, from a user device (104) of a user from amongst a plurality of users, to perform an operation in relation to a file;
determine a global unique identifier (GUID) associated with the file, wherein the GUID uniquely distinguishes the file from other files based on contents of the file;
execute the requested operation in relation to the file based on an access reference graph (ARG), wherein the ARG provides an access control data structure for the files stored on the shared file storage platform, and wherein the ARG references the files stored on a shared file storage platform based the GUID associated with each file;
identify a copy of the file associated with the GUID to exist on a file database (108) of the shared file storage platform, wherein the operation is of creating the file; and
determine orphaned nodes in the ARG so as to delete files corresponding to the determined orphaned nodes from the file database (108) of the shared file storage platform, wherein the orphaned nodes of the ARG are nodes not referenced by an edge of the ARG.
